(19) United States
(12) Patent Application Publication
(10) Pub. No.: US 2013/0311795 A1
(43) Pub. Date: Nov. 21, 2013

(54) POWER SUPPLY MANAGEMENT SYSTEM AND METHOD FOR SERVER

(71) Applicants: HONG FU JIN PRECISION INDUSTRY (SHENZHEN) CO.,LTD., Shenzhen (CN); HON HAI PRECISION INDUSTRY CO., LTD., New Taipei (TW)

(72) Inventors: WEI-DONG CONG, Shenzhen (CN); KANG WU, Shenzhen (CN)

(73) Assignees: HON HAI PRECISION INDUSTRY CO., LTD., New Taipei (TW); HONG FU PRECISION INDUSTRY (ShenZhen) Co., Ltd., Shenzhen (CN)

(21) Appl. No.: 13/867,127

(22) Filed: Apr. 22, 2013

(30) Foreign Application Priority Data
May 18, 2012 (CN) 2012101545887

(51) Int. Cl. G06F 1/26

(52) U.S. Cl. CPC G06F 1/26
USPC 713/300

(57) ABSTRACT

A management system includes two motherboards assigned with different identities, a complex programmable logic device (CPLD), and a switch unit. Each motherboard includes a baseboard management controller (BMC) employed to receive a control signal from a client. The BMC outputs an operation signal corresponding to the control signal and an identity of the motherboard. The CPLD is configured to store the control signal and the identity as a record in a priority list, and determine whether the priority list is a void list. The CPLD outputs a switch signal according to the identity of the record obtained from the priority list in response to the priority list not being a void list. The switch unit is configured to receive the switch signal from the CPLD, and enable a power supply unit to power the corresponding motherboard.

### BACKGROUND

1. Technical Field

The present disclosure relates to a power supply management system for a server.

2. Description of Related Art

Nowadays, a baseboard management controller (BMC) is arranged on a motherboard of a server and is employed to enable the server to be controlled remotely, e.g. powering on or shutting down the server. The server includes one or more motherboards acquiring power from a power supply unit. However, when a user needs to power on the motherboards through the corresponding BMCs, all the motherboards may be powered on at the same time, so that the load for the server may exceed the maximum performance of the power supply unit, and accordingly, the stability of the server is compromised.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a schematic block diagram of an embodiment of a power supply management system of the present disclosure.

FIG. 2 is a flow chart of an embodiment of a power supply management method of the present disclosure.

### DETAILED DESCRIPTION

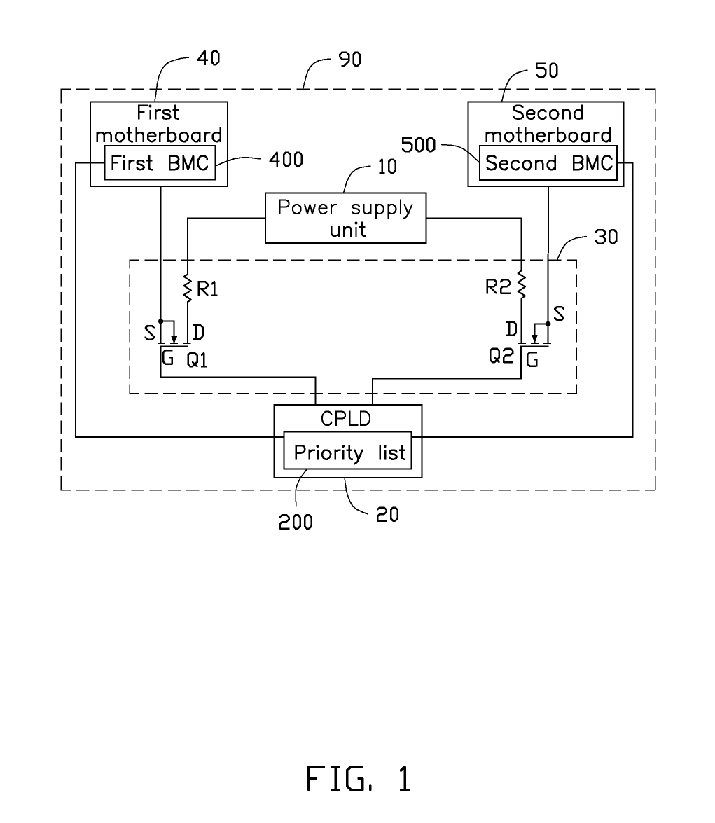

FIG. 1 shows an embodiment of a power supply management system of the present disclosure. The power supply management system applied on a server 90 includes a plurality of motherboards arranged in the server 90, a power supply unit 10, a complex programmable logic device (CPLD) 20, and a switch unit 30 configured to control the power supply unit 10 to provide power to the motherboards. In this embodiment, the motherboards include a first motherboard 40 and a second motherboard 50.

Each of the motherboards is assigned with different identities, and includes a baseboard management controller (BMC). For example, the first motherboard 40 includes a first BMC 400, and assigned with the identity “01”, the second motherboard 50 includes a second BMC 500, and assigned with the identity “02”. The BMCs of the motherboards are employed to receive control signals, e.g. a power on signal to power on the server, from a client. Each of the BMCs is configured to output an operation signal corresponding to the control signal and the identity of the corresponding motherboard. In one embodiment, the first BMC 400 outputs a bootstrap signal, which is the operation signal, and the identity “01” when receiving the power on signal.

The CPLD 20 includes a priority list 200 with a default value of void list. The priority list 200 is configured to store the operation signal and identity as one record outputted by the corresponding BMC. The CPLD 20 determines whether the priority list 200 is a void list. The CPLD 20 obtains a record from the priority list 200 responsive to the priority list 200 being not a void list, and outputs a switch signal corresponding to the identity of the record to the switch unit 30, and then deletes the record from the priority list 200. The CPLD 20 obtains another record from the priority list 200 after a predetermined time, and executes the record. When the priority list 200 is a void list, the CPLD 20 does nothing. In this embodiment, the priority list 200 is a first in first out (FIFO) list.

The switch unit 30 is configured to obtain the switch signal from the CPLD 20, to control the power supply unit 10 to provide power to the corresponding motherboard. In this embodiment, the switch unit 30 includes two electronic switches Q1 and Q2, and two resistors R1 and R2. A first terminal of the electronic switch Q1 is connected to the CPLD 20, configured to receive the switch signal. A second terminal of the electronic switch Q1 is coupled to the power supply unit 10 through the resistor R1. A third terminal of the electronic switch Q1 is coupled to the first motherboard 40. A first terminal of the electronic switch Q2 is connected to the CPLD 20, and is configured to receive the switch signal. A second terminal of the electronic switch Q2 is coupled to the power supply unit 10 through the resistor R2. A third terminal of the electronic switch Q2 is coupled to the second motherboard 50. When the first terminals of the electronic switches Q1 and Q2 are at a low voltage level, such as logic 0, the electronic switches Q1 and Q2 are turned off, and when the first terminals of the electronic switches Q1 and Q2 are at a high voltage level, such as logic 1, the electronic switches Q1 and Q2 are turned on. In this embodiment, the electronic switches Q1 and Q2 are n-channel metal oxide semiconductors (NMOSs), and gates, drains, and sources of the NMOSs are the first, second, and third terminals of the electronic switches Q1 and Q2, respectively.

When the first and second motherboards 40 and 50 are remotely controlled to bootstrap. The CPLD 20 stores the operation signal outputted by the first BMC 400 and the identity corresponding to the first motherboard 40 as a first record in the priority list 200, and stores the operation signal outputted by the second BMC 500 and the identity corresponding to the second motherboard 50 as a second record in the priority list 200. The CPLD 20 then obtains the first record from the priority list 200, and outputs a high voltage level switch signal to the first terminal of the electronic switch Q1. Accordingly, the electronic switch Q1 is turned on, and then the power supply unit 10 provides power for the first motherboard 40. After that, the CPLD 20 deletes the first record and obtains the second record from the priority list 200 after a predetermined time. The CPLD 20 outputs a high voltage level switch signal to the first terminal of the electronic switch Q2 according to the second record. The electronic switch Q2 is turned on, and the power supply unit 10 provides power for the second motherboard 50. Accordingly, the first motherboard 40 and the second motherboard 50 bootstrap in that order.

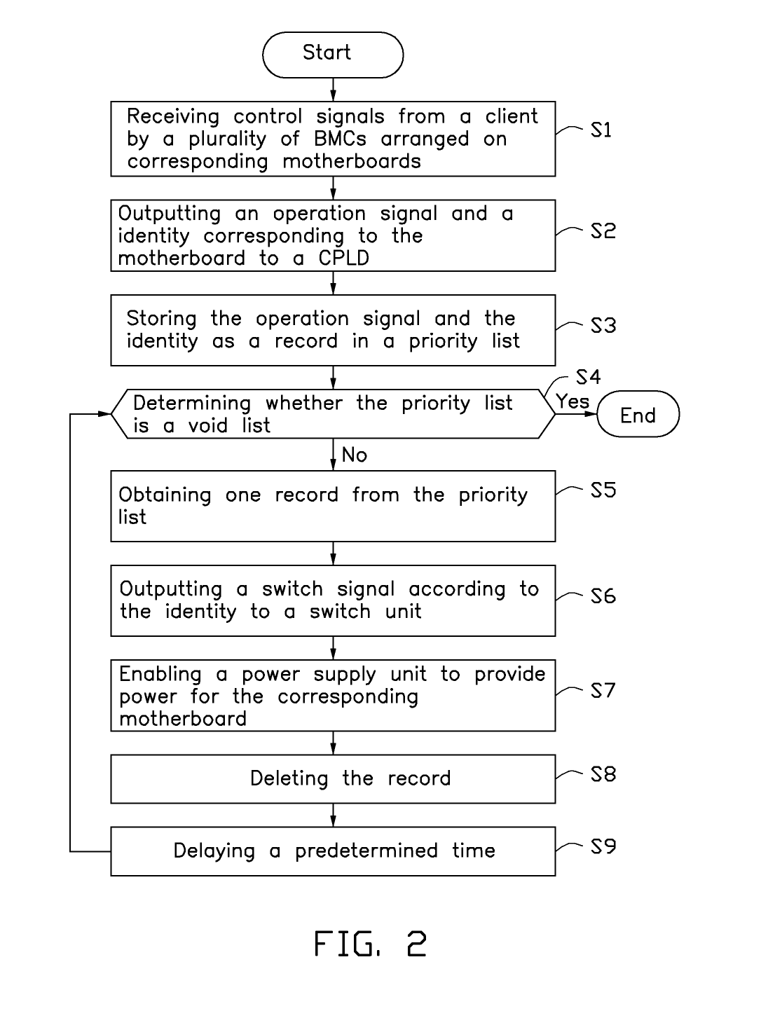

FIG. 2 shows an embodiment of a power supply management method of the present disclosure. The power supply management method includes steps shown below.

In step S1, the BMCs receive control signals from a remote client.

In step S2, each of the BMCs outputs an operation signal corresponding to the control signal and the identity corresponding to the motherboard where the BMC is arranged to the CPLD 20.

In step S3, the CPLD 20 stores the operation signal and the identity as a record in the priority list 200.

In step S4, the CPLD 20 determines whether the priority list 200 is a void list. If the priority list 200 is not a void list, step S5 is implemented, and if the priority list 200 is a void list, the process ends.

In step S5, the CPLD 20 obtains one record from the priority list 200.

In step S6, the CPLD 20 outputs a switch signal corresponding to the identity to the switch unit 30.

In step S7, the switch unit 30 controls the power supply unit 10 to provide power for the corresponding motherboard.

In step S8, the CPLD 20 deletes the record.

In step S9, the CPLD 20 delays for a predetermined time, and the process returns back to the step S4.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A management system, comprising:
at least two motherboards assigned with different identities, wherein each motherboard includes a baseboard management controller (BMC), the BMC receives a control signal, and output an operation signal corresponding to the control signal and an identity of the corresponding motherboard;
a complex programmable logic device (CPLD) configured to store the operation signal and the identity as a record in a priority list, wherein the CPLD determines whether the priority list is a void list, the CPLD outputs a switch signal according to the identity of the record obtained from the priority list in response to the priority list being not a void list; and
a switch unit coupled between the motherboards and the CPLD, configured to receive the switch signal from the CPLD, and enable a power supply unit to power the corresponding motherboard.

2. The management system of claim 1, wherein when the CPLD outputs the switch signal corresponding to the identity of the record, the CPLD deletes the record after a predetermined time.

3. The management system of claim 2, wherein the priority list is a first in first out list.

4. The management system of claim 2, wherein the switch unit comprises a plurality of electronic switches, first terminals of the plurality of electronic switches are coupled to the CPLD, to receive the switch signals from the CPLD, second terminals of the plurality of electronic switches are coupled to the power supply unit, third terminals of the plurality of electronic switches are coupled to the corresponding motherboards, wherein when the first terminals of the plurality of electronic switches receive high level switch signals, the plurality of electronic switches are turned off, when the first terminals of the plurality of electronic switches receive low level switch signals, the plurality of electronic switches are turned on.

5. The management system of the claim 4, wherein the plurality of electronic switches are n-channel metal oxide semiconductors (NMOSs), gates, drains, and sources of the NMOSs are the first, second, and third terminals of the plurality of electronic switches, respectively.

6. A management method for a plurality of motherboards assigned with different identities, comprising:
outputting an operation signal and an identity of a motherboard by a baseboard management controller (BMC) arranged on the motherboard according to a control signal;
storing the operation signal and the identity of the motherboard as a record in a priority list by a complex programmable logic device (CPLD);
determining whether the priority list is a void list;
obtaining a record from the priority list in response to the priority list being not a void list;
outputting a switch signal according to the identity of the record to a switch unit; and
enabling a power supply unit to power the corresponding motherboard by the switch unit.

7. The management method of claim 6, further comprising:
deleting the record; and
returning to the step “determining whether the priority list is a void list by the CPLD” after a predetermined time.

8. The management method of claim 7, wherein the priority list is a first in first out list.
